(19) United States
(12) Patent Application Publication
(10) Pub. No.: US 2020/0250774 A1
(43) Pub. Date: Aug. 6, 2020

(54) SYSTEM AND METHOD FOR PREDICTIVE CLEANING

(71) Applicant: SMARTCLEAN TECHNOLOGIES, PTE. LTD., Singapore (SG)

(72) Inventors: Lav AGARWAL, Singapore (SG); Kush AGARWAL, Singapore (SG); Abhishek MISHRA, Singapore (SG)

(21) Appl. No.: 16/643,872

(22) PCT Filed: Sep. 14, 2018
(86) PCT No.: PCT/SG2018/050473

§ 371 Date: Mar. 3, 2020

(30) Foreign Application Priority Data
Sep. 15, 2017 (SG) 10201707635W

(51) Int. Cl. G06Q 50/16; G06N 5/02; G06N 5/04; G06N 20/00; G06Q 10/00; H04Q 9/00; G08B 21/12

(52) U.S. Cl. CPC G06Q 50/163; G06N 5/02; G06N 5/045; G06N 5/003; G06Q 10/20; H04Q 9/00; G08B 21/12; G06N 20/00

(57) ABSTRACT

Embodiments include a system and method for a virtual cleaning supervisor (VCS) for monitoring the cleanliness of a washroom, alerting cleaners and/or stakeholders and predicting cleaning schedules. Sensors are installed within a washroom at various locations that measure its cleanliness in real time. Sensors can measure patterns of use, wetness on floors, indoor air quality by detecting concentrations of gases and receive input from users. The sensor network does not rely on the use of a camera or other image based system. Artificial intelligence (AI) based machine learning algorithms on cloud servers can match the observed values with historical values to detect anomalies and send alerts if cleaning or a check is required. The system can also generate reports for facility managers to track cleaning operations and cleaning companies to evaluate their workforce using a time to service parameter.

### TECHNICAL FIELD

The invention relates to facility management, and more specifically, to a system and method of detecting and identifying anomalies in a washroom using sensors and sending task-specific alerts to facility workers or managers.

### BACKGROUND

Public or commercial washrooms typically include appliances such as toilets, urinals and sinks with faucets. Consumables and dispensers accompany the appliances such as soap, paper towels, tissues, disposable seat covers, urinal deodorant supplies, bins and air fresheners. Cleaning, maintenance and stocking amenities can be time consuming and expensive.

In a conventional approach, a facility employee will make periodic visits to a washroom for inspection and/or cleaning. A checklist may be used to ensure that a given set of tasks are complete. The checklist may also include a list of amenities to stock along with a list of scheduled times to return. If a supervisor or manager determines that a washroom is inadequately maintained, he/she can increase the frequency of cleaning operations. However, this assumes that more frequent cleaning operations will lead to better cleanliness. This assumption can be incorrect and lead to an inefficient use of resources.

In many washrooms, the number of users varies with traffic in areas as well as time intervals of the day. For example, traffic in a particular area will often be higher during scheduled events. A conference hall might only have traffic when events are hosted. Similarly, an area with restaurant facilities will usually experience higher traffic during mid-day and evenings. Likewise, an airport will experience higher traffic when commuters are present based on flight schedules.

Accordingly, increasing the frequency of cleaning operations may be ineffective. Regardless of increased visits by workers, a washroom may be inadequately maintained during certain periods of time. A supervisor may try to estimate and customize the frequency of cleaning operations during particular time intervals. However, this can be difficult without accurate knowledge of future events. Further, it can be expensive to staff washroom facilities based on sporadic schedules. Moreover, increasing the frequency of cleaning operations does not account for other variables. Habits of users can be unpredictable. Certain groups of people may use more consumables than others. Moreover, sporadic events (e.g. a leaky valve) can also be problematic. Recent efforts have focused on more accurate methods of prediction.

U.S. Pat. No. 6,389,331 describes a technique for monitoring performance of a facility management system. Data is collected from a group of subsystems and analyzed statistically to estimate when a component might require service. The invention helps analyze data collected from heating, ventilation, air conditioning and security systems.

Similarly, International Patent Application No. WO2013144787A1 describes a system for supporting facilities management services. A computing device allows a user to input feedback that is recorded on a central server or computer. An alert is sent to a mobile device of a supervisor when criteria are satisfied. The invention can provide a system for supporting outsourcing of facility management services to a third party.

U.S. patent application Ser. No. 12/290,914 describes a similar approach toward data collected from sensors in a restroom. Sensors monitor the use of fixtures and provide an indication of the need for replenishment of consumables. The system can provide a supervisor or other employee an indication of the need for replenishment of consumables such as paper towels.

While these inventions offer some improvements to conventional approaches of managing facilities, they have shortcomings. They rely on the assumption that maintenance requirements are correlated with traffic. They do not account for variability in use, unpredictable or sporadic events. Accordingly, there is a need for an improved system and method for washroom monitoring.

The improved system should overcome the limitations of conventional approaches. It should use smart monitoring and an alerting system to analyze real-time data from multiple sensors across different installation locations. It should perform anomaly detection and alert various stakeholders when appropriate.

### SUMMARY OF THE INVENTION

The invention recognizes that there is a need for an improved system and method for washroom monitoring. A collection of sensors and devices can detect usage, supplies, air quality and accumulated water in a washroom or similar facility. The system can use a rule-based and artificial intelligence (AI) based smart alerting framework that builds on prior and real-time sensor data, and consumer logged feedback, to collectively form an intelligent automated alerting system. This system design, along with a rules engine and AI algorithms, can detect anomalies and send task-specific alerts to respective endpoints in real-time. It can also monitor and track the completion of tasks.

The following summary is provided to facilitate an understanding of some of the innovative features unique to the disclosed embodiments and is not intended to be a full description. A full appreciation of the various aspects of the embodiments disclosed herein can be gained by taking into consideration the entire specification, claims, drawings, and abstract as a whole.

Embodiments include a system and method for a virtual cleaning supervisor (VCS) for predictive cleaning of washrooms. Sensors within a washroom measure gases, moisture and consumer activity. Washroom users and/or facility workers can also provide input through interfaces. Artificial intelligence (AI) based machine learning algorithms on cloud servers can compare observed values with historical values to detect anomalies and send alerts if cleaning or a check is required. The system can generate reports that allow facility managers to track cleaning operations and cleaning companies to evaluate their workforce.

Embodiments also include a system for predictive cleaning of a facility comprised of (a) one or more sensors for collecting sensor data on air quality, people count, dispenser fill levels, temperature, humidity and/or wetness, (b) an interface for receiving input from users and/or facility workers, (c) a database for storing sensor data and input from users and/or facility workers and (d) an analytics engine. The analytics engine can detect anomalies in sensor data and/or input from users and/or facility workers. The analytics engine can also schedule cleaning and/or maintenance based on anomaly detection and predict cleaning and/or maintenance needs based on patterns of sensor data and/or input from users and/or facility workers.

Embodiments also include a method for predictive cleaning of a facility comprised of steps of (a) collecting sensor data from sensors and/or devices, (b) collecting user input from a user interface, (c) identifying anomalies, (d) alerting one or more workers and/or stakeholders, (e) determining an alert time-to-completion for anomalies and (f) predicting cleaning and/or maintenance needs based on patterns of sensor data and/or user input. The user input can include information entered by users and/or facility workers.

While the invention is described for use in washroom facilities, it has other applications. It is useful in other facilities that require observation and periodic cleaning and/or maintenance. For example, it can be used to improve efficiency and the effectiveness of cleaning and maintenance services in kitchens, cafeterias, lounges, conference rooms, transit centers, theme parks, restaurants/cafes and other gathering areas. Further, the invention can be modified to include additional sensors and/or remove one or more of those described herein.

### INTRODUCTION

A first aspect of the invention is a system (i.e. virtual cleaning supervisor) for monitoring the cleanliness and other conditions of a washroom or other facility.

A second aspect of the invention is a system of sensors and devices for a washroom that detect, air quality, usage patterns, wetness, consumables, etc.

A third aspect of the invention is an anomaly detection module that operates on data from continuous time-based event sources to establish standard operational levels for a facility. Deviations and/or anomalies can be identified for subsequent action.

A fourth aspect of the invention is an IoT sensor network design and associated cloud and local system architecture for a smart clean detection and alerting system.

A fifth aspect of the invention is an alerting module that sends alerts to endpoints for cleaning operations.

A sixth aspect of the invention is an AI based virtual cleaning supervisor (VCS) that can send alerts to endpoints for cleaning operations.

A seventh aspect of the invention is a system that records non-continuous discrete data sources such as consumer feedback and cleaner logs.

An eighth aspect of the invention is an algorithm that learns normal patterns and detects anomalous behavior. The algorithm can rely on frequency domain or time domain techniques or a hybrid approach. Absolute maximum thresholds can also be set.

A ninth aspect of the invention is an anomaly detection module within the AI engine that can operate on time continuous data generated by sensors.

A tenth aspect of the invention is an alerting module that sends a decision to an endpoint under particular conditions.

An eleventh aspect of the invention is a system of time-based weights assigned to sensors and/or devices that can affect the decision made by the AI engine.

A twelfth aspect of the invention is a system that uses feedback and logging modules to measure cleaner performance and provide ratings by noting, for example, time to service details.

A thirteenth aspect of the invention is an anomaly detection process that computes features from time-based sensor data and maintains an estimate of their correlation from the history of such data at similar times.

A fourteenth aspect of the invention is a cause determining generative module that explains possible causes from historical sensor data.

### BRIEF DESCRIPTION OF FIGURES

The drawings described herein are for illustrative purposes only of selected embodiments and not all possible implementations, and are not intended to limit the scope of the present disclosure.

The summary above, as well as the following detailed description of illustrative embodiments, is better understood when read in conjunction with the appended drawings. For the purpose of illustrating the disclosure, exemplary constructions of the disclosure are shown in the drawings. However, the disclosure is not limited to specific methods and instrumentalities disclosed herein. Moreover, the drawings are not to scale.

FIG. 1 depicts the sensor subsystem, consumer subsystem and the data analytics engine of the system for predictive cleaning.

FIG. 2 depicts a user interface such as a mobile application (“App”) operated on a digital medium such as a computer tablet or smartphone.

FIG. 3 depicts the data analytics engine and its access to sensors and stakeholders.

FIG. 4 depicts an alternate configuration of the data analytics engine and its access to sensors and stakeholders.

FIG. 5 depicts the fault monitoring system.

FIG. 6 depicts various stakeholders within the ecosystem who can receive data and alerts generated by the system.

FIG. 7 depicts the alert tracking module for tracking completion of tasks and generating a time to completion score (TTC).

FIG. 8 depicts various sensors that contribute data to the AI engine for predictions and reports.

FIG. 9A depicts sensors arranged in a washroom or similar room.

FIG. 9B depicts sensors arranged in a corridor of a facility such as mall, hospital, etc.

FIG. 10 is a flow chart of the steps that are computed synchronously by initializing compute modules after receiving data from sensors.

FIG. 11 depicts the anomaly detection module within the AI engine that operates on time continuous data generated by sensors such as those that measure usage patterns and air quality.

FIG. 12 depicts the alerting module that can send a decision to an endpoint under particular conditions.

FIG. 13 depicts time-based weights assigned to various sensors that can affect the decision made by the AI engine.

FIG. 14 is a flowchart of the steps in initiating the alerting process by fetching a list of attached stakeholders and preparing messages according to the sensor and alert types.

FIG. 15 depicts the system's use of feedback and logging modules to measure cleaner performance and provide ratings by noting time to service details.

FIG. 16 depicts the anomaly detection process that computes features from time-based sensor data and maintains an estimate of their correlation from the history of such data at similar times.

FIG. 17 depicts the cause determining generative module that explains possible causes in historical data from an installation location.

FIG. 18 depicts a dashboard provided to a stakeholder such as facility manager, cleaning company or cleaner for various actions to collate data and generate reports and alerts.

FIG. 19 depicts a screenshot of a device management service for a facility manager to create virtual installation locations and further claim/attach sensors for the algorithm to generate predictions for each installation.

### NUMERICAL REFERENCE FEATURES

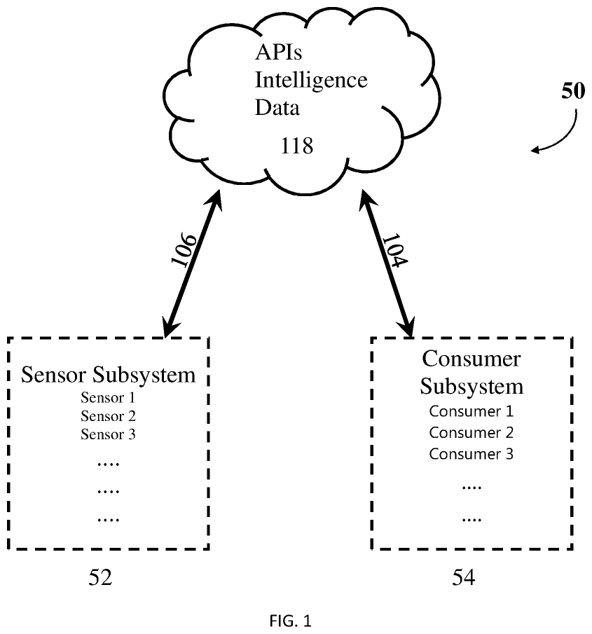

The following list of index numbers and associated features is intended for ease of reference to FIG. 1 through FIG. 19 and illustrative embodiments of the disclosure:
50—Virtual Cleaning Supervisor (VCS)
52—Sensor Subsystem
54—Consumer Subsystem
64—Floor Plan depicted on User Interface
66—Hardware for User Interface (e.g. tablet computer)
68—Installation Locations depicted on User Interface
70—Touch Screen Input depicted on User Interface
100—Consumer
102—System of Sensors
104—Access Key (user)
106—Access Key (sensor)
108—Consumer Facing APIs
110—Internal API
112—Local Memory Storage
114—AI Engine
116—Central Communication Link
118—Analytics Engine (cloud network)
118A—Analytics Engine (local network)
118B—Analytics Engine (alternative arrangement on local network)
120A—Communication Links (Internal API and Disk Storage Media)
120B—Communication Links (Internal API and Disk Storage Media)
122—Disk Storage Media
124A—Links
124B—Links (alternative arrangement)
126—Communication Link (AI Engine and Memory)
128—Device APIs
132—Fault Monitoring System
140—Facility Manager
142—Cleaning Company
144—Cleaner
146—Two-way link between Facility Managers and Consumer Facing APIs
148—One-way link between Cleaners and Consumer Facing APIs
150—Two-way link between Cleaning Companies and Consumer Facing APIs
152—System Integrators/Partners
154—Users (e.g. facility managers)
156A—Incoming Alert 1 from Analytics Engine
156B—Incoming Alert 2 from Analytics Engine
158—Alert Tracking System
160A—Process Flow for Alert 1 tracking
1608—Process Flow for Alert 2 tracking
170—Success/Fail TTS
180—Consumer Feedback and Task Logging Device
182—Air Quality Monitor
184—People Counter
186—Wetness Sensor
188—Bidirectional Communication Link
190—Unidirectional Communication Link
192—Gateway Device
194—Floor of Washroom
196—Door of Washroom
198—Temperature/humidity sensor
200—Location/tracking sensor
216—Anomaly Detection Module
300—Cause Inference Engine
320A—Computational Model for Artificial Intelligence (AI) Component
320B—Cause Determining Artificial Intelligence (AI) Model

### DETAILED DESCRIPTION OF THE INVENTION

### Definitions

Reference in this specification to “one embodiment/aspect” or “an embodiment/aspect” means that a particular feature, structure, or characteristic described in connection with the embodiment/aspect is included in at least one embodiment/aspect of the disclosure. The use of the phrase “in one embodiment/aspect” or “in another embodiment/aspect” in various places in the specification are not necessarily all referring to the same embodiment/aspect, nor are separate or alternative embodiments/aspects mutually exclusive of other embodiments/aspects. Moreover, various features are described which may be exhibited by some embodiments/aspects and not by others. Similarly, various requirements are described which may be requirements for some embodiments/aspects but not other embodiments/aspects. Embodiment and aspect can be in certain instances be used interchangeably.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Directional and/or relational terms such as, but not limited to, left, right, nadir, apex, top, bottom, vertical, horizontal, back, front, and lateral are relative to each other, are dependent on the specific orientation of an applicable element or article, are used accordingly to aid in the description of the various embodiments in this specification and the appended claims, and are not necessarily intended to be construed as limiting.

As applicable, the terms “about” or “generally”, as used herein in the specification and appended claims, and unless otherwise indicated, means a margin of +/−20%. Also, as applicable, the term “substantially” as used herein in the specification and appended claims, unless otherwise indicated, means a margin of +/−10%. It is to be appreciated that not all uses of the above terms are quantifiable such that the referenced ranges can be applied.

The term “access key” refers to are means for preliminary device authentication and for implementing data rate controls. A device access key can be shared by more than one device based on some grouping criteria.

The term “analog” or “analog signal” refers to any continuous signal for which the time varying feature (variable) of the signal is a representation of some other time varying quantity (i.e., analogous to another time varying signal).

The term “anomaly detection” or “outlier detection” refers to the identification of rare items, events or observations which raise suspicions by differing significantly from the majority (or expected) data. Typically the anomalous item(s) will indicate to some kind of problem and/or mess at a washroom facility.

The term “application programing interface” or “API” refers to a set of subroutine definitions, protocols and tools for building software. In general terms, it is a set of clearly defined methods of communication between various components.

The term “cloud” or “cloud computing” refers to an information technology (IT) paradigm that enables ubiquitous access to shared pools of configurable system resources and higher-level services that can be rapidly provisioned with minimal management effort, often over the Internet.

The term “controller” refers to a comparative device that receives an input signal from a measured process variable, compares this value with that of a predetermined control point value (set point), and determines the appropriate amount of output signal required by the final control element to provide corrective action within a control loop. An electronic controller uses electrical signals and digital algorithms to perform its receptive, comparative and corrective functions.

The term “Controller Area Network,” “CAN” or “CAN bus” refers to a vehicle bus standard designed to allow microcontrollers and devices to communicate with each other in applications without a host computer.

The term “ecosystem” refers to product platforms defined by core components and complemented by applications in a periphery.

A “gateway device” refers to a hardware device that acts as a “gate” between two networks. It can be a router, firewall, server, or other device that enables traffic to flow in and out of the network.

The term “Internet of Things” or “IoT” refers to a network of physical devices, vehicles, home appliances, and other items embedded with electronics, software, sensors, actuators, and connectivity which enables them to connect and exchange data, creating opportunities for more direct integration of the physical world into computer-based systems, resulting in efficiency improvements, economic benefits, and reduced human exertions.

The term “installation location” refers to any area where a single device or a group of sensing devices are installed to monitor the requirement for cleaning. The system can tag such locations and associate other parameters such as stakeholder alerts, frequency of alerts, etc. Each installation location can be represented by a unique identifier and a user-friendly display name that denotes its physical location.

The term “near-field communication” or “NFC” refers to a set of communication protocols that enable two electronic devices, one of which is usually a portable device such as a smartphone, to establish communication by bringing them within a certain distance of each other (e.g. 4 cm/1.6 inches).

The term “stakeholder” refers to any person related to the facility operations. This can include cleaners, attendants, supervisors, managers and/or others.

Other technical terms used herein have their ordinary meaning in the art that they are used, as exemplified by a variety of technical dictionaries. The particular values and configurations discussed in these non-limiting examples can be varied and are cited merely to illustrate at least one embodiment and are not intended to limit the scope thereof.

### Description of Preferred Embodiments

An important aspect of facility management is to ensure cleanliness of various areas including washrooms, pantry areas, corridors, lobbies, cafeterias, etc. This is particularly important in public facilities, such as malls, airports, hospitals, and cafeterias. In conventional practice, the desired frequency of cleaning operations is varied in tenders quoted to cleaning companies. However, this approach has two underlying assumptions that may be invalid in many scenarios and not lead to expected outcomes. First, it assumes that more frequent cleaning operations correlates to better cleanliness. Second, it assumes that the cleaning tasks are being effectively performed in the absence of a supervisor.

The first assumption is invalidated in cases where the frequency of usage of concerned areas is distributed within certain time intervals of the day. This, in turn, leads to the likelihood of uncleanliness around those times. Some try to estimate and customize this frequency through periodic manual checks and attempts to optimize cleaning operations at specific time intervals. However, this approach has limitations and may not be effective. The second assumption is invalidated with employees who are not diligent and thorough with each aspect of cleaning and maintenance.

The invention recognizes that a smart monitoring and alerting system can help perform need based predictive cleaning operations, instead of schedule based activities. Advances in Internet of Things (loT) technologies and interconnected systems are used in this regard. The concept is to equip a facility with appropriate sensors that automatically evaluate the cleanliness of concerned locations through real-time monitoring. These sensors can include air quality monitors, counters to determine the number of people entering and exiting, interfaces for feedback from users, temperature/humidity sensors along with sensors that measuring fill levels of consumables. Alerts can be sent to one or more stakeholders when values cross specific thresholds or values cross a pre-defined range of sensor measurements.

However, this approach can have limitations in particular scenarios. Efforts should be taken to avoid false positive alerts. For air quality monitoring, high accuracy sensors that are sensitive to a specific or low spectrum of gases may be necessary. Otherwise, false positives can be generated when cleaning solvents are used that result in higher levels of odors or another indication of poor air quality. That is, if the air quality in a location within the facility is not within desired or usual ranges, the system will alert concerned stakeholders to resolve the issue.

Embodiments include an IoT sensor network design and associated cloud and local system architectures for a smart cleanliness detection and alerting system. The sensor network comprises devices for detecting various aspects of cleanliness such as air quality, usage patterns, feedback from users, consumable fill levels, temperature and humidity and/or others. Appropriate system services are provided to deal with various aspects of stakeholders in the ecosystem. The aim of providing this ecosystem is to develop an AI based virtual cleaning supervisor (VCS) that can send alerts to concerned endpoints for automating a facility's cleaning operations.

A smart alerting system can include two modules: an anomaly detection module and an alerting module. The anomaly detection module operates on data from continuous time-based or discrete time-based event sources such as air quality, spill detection, consumable fill level or people count to evaluate normal behavior and operational levels of the facility. Deviations or anomalies from operational ranges can be detected and tagged for further analysis. When deemed appropriate, the alerting module sends an alert to a maintenance worker or stakeholder.

Various kinds of algorithms can be used to identify normal patterns and detect anomalous behavior based on deviations from the norm. These algorithms can use frequency domain techniques, time domain techniques or a hybrid approach. Absolute maximum thresholds can also be set so that alerts are sent under particular circumstances.

In some implementations, non-continuous discrete data sources such as consumer feedback and/or cleaner logs can also provide data to the system. This class of sensor data is handled by decision trees and/or another such “if-then-else” rules based system. For example, if more than a certain number of negative feedbacks are registered within a duration of time, the system can send an alert to concerned endpoints.

In preferred embodiments, the system provides data visualization, report generation, adding/deleting users, and/or others. In one workflow, facility managers and cleaning companies register for the system using unique identities. Cleaners are added into the system by respective cleaning companies. Facility managers can provide access to cleaning companies to manage endpoints that receive SMS or app based notifications generated by the VCS. The system can additionally be integrated with building management systems (BMS) to inter-operate within the existing setup of the facility infrastructure.

In some implementations, the type of day (weekends/weekdays) and facility (malls, hotels, and/or others) is also considered by the alerting system when making a decision to send alerts. Further, the system architecture design provides APIs to stakeholders and users for creating, accessing and consuming data from the sensing sources installed in the facility.

### Ecosystem for Predictive Cleaning

FIG. 1 depicts the basic components of the virtual cleaning supervisor (VCS) 50. The ecosystem includes three primary sub-systems: a sensor subsystem 52, a data and analytics engine (“analytics engine”) 118, and a consumer subsystem 54. Bi-directional communication links (104 and 106) are provided in specific protocols and methods. The sensor subsystem 52 can include various sensors to evaluate cleanliness of an area. The consumer subsystem 54 can include interfaces for input from users (i.e. visitors to a facility) and/or maintenance workers. Data is sent to cloud servers through links that can be based on a communication spectrum such as WiFi, Bluetooth, Sigfox, Lora, nb-loT (narrow band IoT), cellular, and/or others.

Some devices within the eco-system may require a downlink from the cloud servers to facilitate their operation, for example, obtaining the current time of the day to alter their functional algorithms. The consumer subsystem can include entities that utilize data and results from the cloud servers through links 104 on their computing devices. The analytics engine 118 can implement methods and communication protocols for interacting with the sensor subsystem 52 and the consumer subsystem 54 and artificial intelligence (AI) based algorithms for real-time online evaluation of anomalies and alerting.

In some embodiments, the analytics engine 118 resides on servers located outside of the facility. This provides a centralized single point of access for the system in a software as a service (SaaS) model where a cluster of VCS servers is used to provide services to multiple clients. In alternative embodiments, the data and analytics system resides on physical compute devices located within the facility's infrastructure (118A, 118B). This represents a standalone deployment used in scenarios where internet connectivity is absent or data transmission outside the facility is not desired. The system can operate through the facility's intranet using WiFi or other proprietary protocols for data transmission.

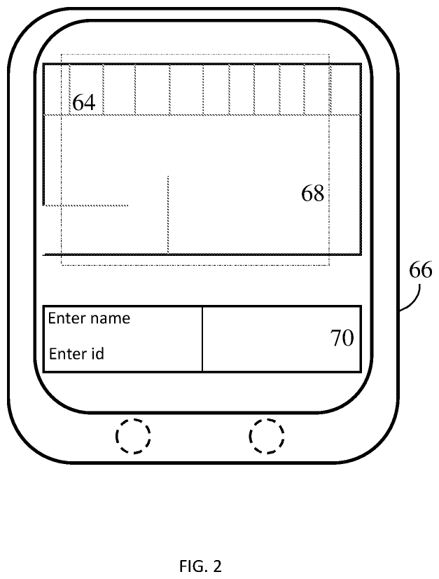

FIG. 2 depicts a user interface for assigning unique location identifiers to installation locations within a facility. Floor plans of levels depicted by 64 can be stored as responsive images in a database. A mobile application on a digital medium such as a tablet computer 66 or other computing device such as a phone, laptop or desktop can be used for entering the site data. For a given floor, the interface displays the floor map 64 and the user indicates installation locations on the floor by drawing a box as depicted by 68. Further information such as a human friendly display name, id, and/or other relevant parameters can also be input 70. Following this process, others can access the tagged images for installing sensors and associating them with pre-determined locations as performed by the process mentioned above. This process automates the sensor installation and location assignment process.

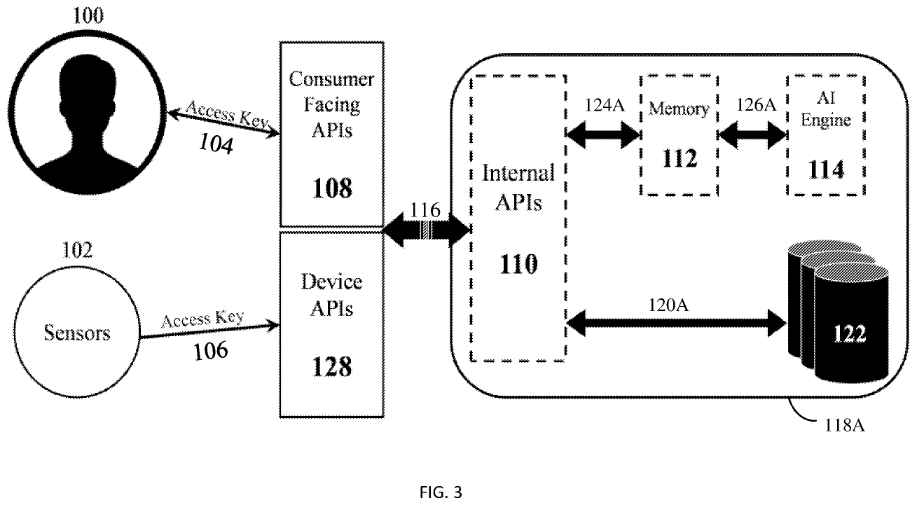

FIG. 3 depicts the analytics engine and various communication links. Data from consumers 100 and sensors 102 are relayed to the analytics engine 118A through access keys (104, 106). The analytics engine 118A includes Internal APIs 110, memory 112, an AI engine 114. Each has a two-way link (124A, 126A). The Internal APIs are also linked 120A with storage media 122.

Sensors and devices (“sensors”) 102 within a washroom facility send data to the data and analytics engine 118A using an access key 106 provided during installation. The access key can be used for preliminary device authentication and for implementing rate data controls. In a preferred embodiment, the access key is shared by more than one device based on grouping criteria. A usual grouping criterion is a common key for all devices within each facility of the ecosystem. Sensors can have a limit of data imposed to a certain number of requests per second or per minute. All sensors within the ecosystem can use a common device API endpoint service provided as 128. This API service is provided primarily for devices to push data to the server. In a preferred embodiment, the cloud server is closed to network connections except those originating through device APIs 128 and consumer APIs 108.

Consumers 100 can include facility managers, cleaning companies, system integrators and partners or cleaners who utilize an access key 104 for interacting with the system. Consumer facing APIs 108 allow data transfer from cloud services and storage media to consumers. The link 104 may require further authentication in conjunction with the access key such as username-password, token based, and/or others. In typical embodiments, consumers can register with the system using their business registration numbers, unique identity IDs, or passport numbers followed by e-mail or phone number verification. Access keys can be provided after entering into a business agreement with providers of the VCS eco-system. Following these steps, consumers can access data about their installed devices and associated reports. The device and consumer facing APIs, in turn, can communicate with the back-end cloud server for routing data and requests through a central communication link 116. This link can be callable by the two APIs in the ecosystem and closed for other connection types and origins. This design is helpful for maintaining data and services in a secure abstract black box that is agnostic to the devices and consumers.

The world facing interaction layer ends at connection 116, and deeper levels of cloud hierarchy are invisible to any device or user. The communication link 116 can be based on protocols such as MQTT, UDP, TCP, and/or others. In typical implementations, 116 is based on TCP/IP based HTTP/HTTPS endpoint services callable only through consumer and device facing APIs.

FIG. 3 depicts an implementation of system services where the AI engine 114 resides on the same machine. The AI engine detects anomalies for any installation streaming real-time data from various sensor modalities. The AI engine receives data from a local memory store 112, which can be a memory cache with persistence. The memory store 112 can also be a disk storage based database: relational, noSQL, and/or others. Data obtained from devices is routed by device APIs to an internal API 110. The internal API is responsible for routing and handling data internally based on its type and computational requirement. This internal API implements an HTTP/HTTPS service for handling data from device and consumer facing APIs. In some implementations, this process can be performed through messages using socket.io, MQTT, CoAP, XMPP, and/or others. In a typical scenario, on receipt of data from a sensor device, the internal APIs call its respective handler to process this data further. Likewise, for data request by consumer facing APIs, the internal APIs implement appropriate processes to respond to this request. Internal APIs can be implemented in a multithreaded or multi-process programming paradigm.

The internal APIs communicate with the memory 112 using messages. In some implementations, the AI engine implements an HTTP micro-service which internal APIs 110 can call. This in turn initiates the AI engine to process data. In preferred implementations, the AI engine implements a worker thread listening for messages on a channel using MQTT, TCP/IP, and/or other message telemetry protocols. Data can be passed by the internal APIs to this thread as a message for the AI engine to write and handle. Data can also be written by internal APIs directly to the memory 112 followed by a trigger being sent to the AI engine indicating this change. This process allows the AI engine to be developed, executed and debugged independently from the internal APIs catering to requests from devices and consumers. The memory 112 forms a crucial part and an efficient way of exchanging structured data between the two separate processes. This design strategy is preferred rather than implementing a program specific queue and/or arrays. The communication link between the AI engine and memory for data storage 126A is also depicted. In most implementations, the AI engine and memory store reside on the same computing device, in which case link 126A is an internal port based TCP/IP link.

In other implementations, the memory 112 can reside on distributed computing devices with provision for strict data consistency according to the CAP theorem, that is, every read must return the most recent write. This ensures that triggers received by the AI engine's thread result in the engine processing the correct data. The memory 112 stores data from sensors necessarily in a limited time window frame, that is, data stored is automatically expired and consequently deleted after a fixed interval from data receipt time. The reason for this depends on the AI algorithm implemented and has been detailed in further points. The memory 112 can be implemented as a data store based on popular frameworks such as Redis, Memcachedb, LevelDB, LMDB, and/or others.

Certain data is stored on disk based storage media (i.e. persistent database) depicted by 122. The disk based storage media 122 is usually an eventually consistent distributed noSQL key-value persistent data store. It can store data about consumers and devices in the eco-system provided. It can also store time-based data logs from every device within the eco-system for future access and processing. Some critical data from 112 can be moved by the APIs to 122 for future retrieval. This critical data is typically the anomalies that were detected by the AI engine for any sensor and any consequent alerts hence generated. In certain implementations, this database can be implemented as a relational one.

Communication between the internal APIs and the storage media 122 is facilitated by communication links 120A. These links are accessible only to the root users and internal APIs. The persistent database is accessed by the devices 102 indirectly to write their data log for each day. The database is also indirectly available to authenticated consumers 100 for viewing data about their facility. Data from storage media 122 can be moved to a physical storage medium after a specified duration for further access and deleted from the online store.

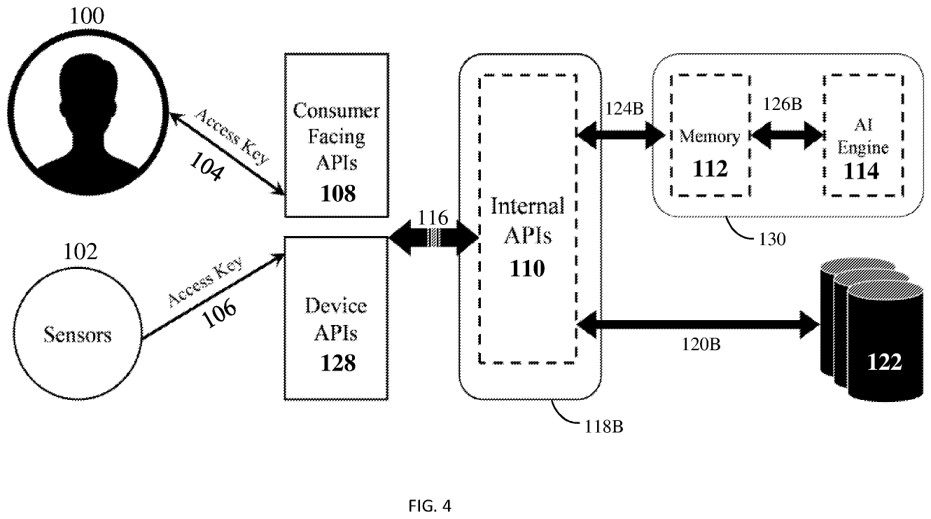

FIG. 4 depicts an alternate configuration of the VCS data and analytics engine 118B. Here, the AI engine 114 and the memory 112 reside on a separate machine 130 from that of the internal APIs 118B. A two-way link between the AI engine 114 and the memory 112 is depicted 126B.

This implementation can be utilized when different computational and networking requirements are required by both compute modules. Links 124B facilitate communication between the AI engine and the internal APIs for data processing and intelligence. The link 124B can be based on TCP/IP based messaging. In some implementations, the persistent database 122 can also be located on a different compute module cluster, where communication and data interchange is handled by link 120B. The link 120B can also a TCP/IP based communication link.

Both the embodiments depicted in FIG. 3 and FIG. 4 can be implemented as cloud based services or as a standalone system within the facility's infrastructure without any requirement for internet connectivity.

Fault Monitoring System

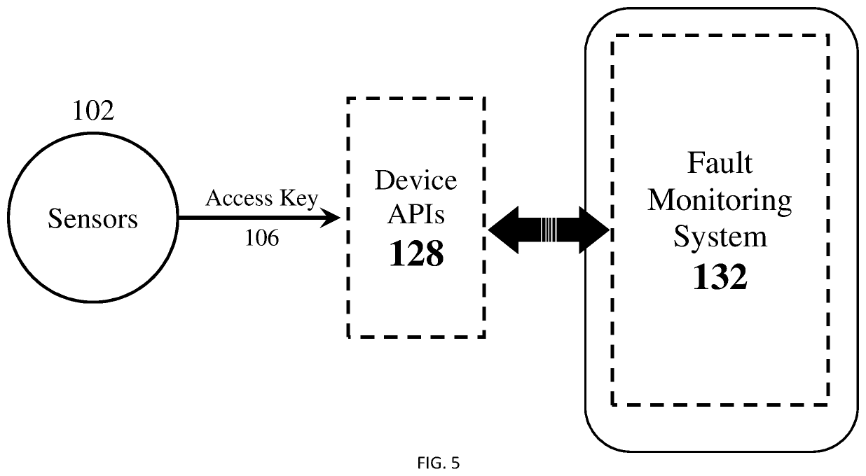

FIG. 5 depicts a sensor node fault monitoring system 132 that can be implemented for indicating if the devices within the ecosystem are functional. As described above, sensors 102 use an access key 106 and device APIs 128 to send data to a fault monitoring system 132. The fault monitoring system is a module of the analytics engine 118 and keeps track of all provisioned devices, notifying appropriate endpoints on failure of a particular device to send data for a certain time duration, faulty data and/or others.

The fault monitoring system 132 can be implemented as a process flow that tracks the average data ping rate of every device. If the rate falls below a threshold for a predefined time duration, the system can alert concerned endpoints about device malfunction. These thresholds are decided based on ground truth knowledge of how fast every device in the ecosystem has been programmed to ping data to a server. However, the above is mostly true and applicable for time continuous sensors. Event based sensors may require a more relaxed threshold setting spanning multiple hours to few days. In other implementations, all of the devices are programmed to send a ping of normal operation at pre-defined time intervals to the server. Failure to send activity pings to the server may stem from device faults to network failures. Software based faults can be handled by the devices in the form of micro-controller reboots and power recycles. Error in reading or detection components of the device can be sent as error messages to the server for proper handling. These measures are implemented to pro-actively understand and rectify any malfunctioning sensor nodes within the ecosystem and thereby maintain the integrity of data and overall performance for the facility.

The fault monitoring system can also determine if a sensor module is giving accurate readings or not. For example, if a sensor type is known to output values within a certain value range, deviations from this range for extended or intermittent periods of time may be tagged as erroneous/faulty sensor device, requiring physical device replacement.

### Stakeholders

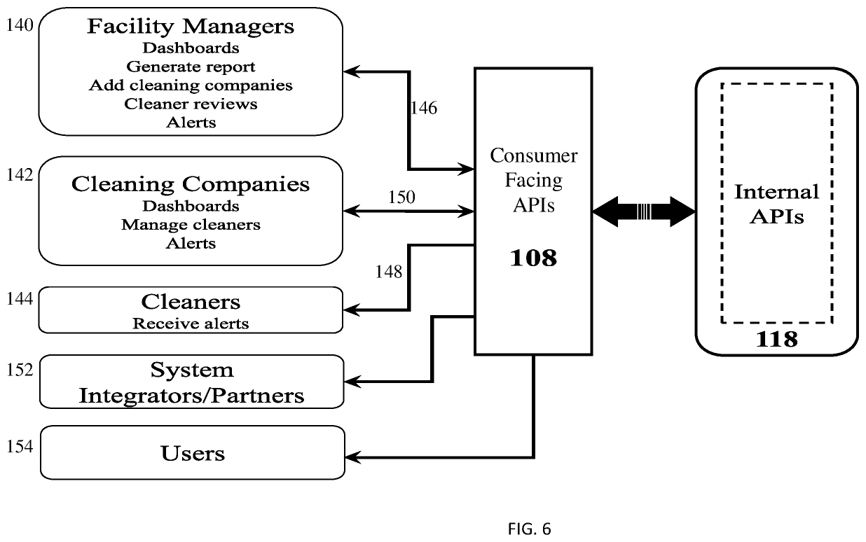

FIG. 6 depicts stakeholders within the ecosystem. The stakeholders can include facility managers 140, cleaning companies 142, cleaners 144, system integrators or partners 152 and users 154. Facility managers can include entities responsible for maintaining the cleanliness of a facility. In some implementations, facility managers use a web based dashboard for real-time data visualization of sensor data. The dashboard communicates with the database using the consumer facing APIs 108. Further, facility managers can download comprehensive reports about their facility status for specific days. These reports summarize various alerts for installation locations that were sent to cleaners, consumer feedback, quantitative scores and/or others. In some implementations, this report generation process is automated by the server and sent to facility managers at specific time intervals that can be customized through their dashboard.

A facility manager can provide access to certain cleaning companies for managing the cleaner fleet registered in the ecosystem. Cleaning companies can be searched using their business registration numbers or other unique identities. This operation is required in operational scenarios where facility management companies sub-contract one or more cleaning companies to perform cleaning operations in the facility. Additionally, facility managers can view cleaner reviews provided by past employers and provide reviews. This helps in maintaining a central database about cleaners using their unique identities.

Facility managers can also choose to receive alerts about their facility on a computing device such as a computer (using an online dashboard) or mobile device (using an application). The information and data interchange is facilitated through a bi-directional communication link 146 with the consumer facing APIs of the ecosystem. Cleaning companies 142 manage the cleaner workforce within a facility. Cleaning companies 142 can interact with consumer facing APIs using communication links 150. Their dashboard allows them to register using their unique business identification identities and subsequently create profiles for cleaners. In scenarios where facility management company handles the cleaner workforce (no cleaning company involved), the system requires facility managers to register as both types during registration. Cleaning companies can receive alerts on their computing devices (dashboard or mobile applications) about relevant events, for example, inventory management.

Cleaners 144 are generally the endpoints who receive alerts sent by the VCS alerting and tracking module for performing the cleaning operations. These can be attendants responsible for executing cleaning jobs, supervisors in charge or any person responsible for execution of cleaning jobs in the facility. These alerts can be in the form of mobile number based SMS, application based notifications or voice calls. By default, registered cleaners in the system are notified by SMS. On installation of the mobile application and sign in, the type is automatically changed by the server to indicate an option for app based notifications or voice calls and device tokens updated accordingly in the database. In some implementations, the system can be notified of delivery failure scenarios and perform alternate processes to ensure delivery success or fail and alert the appropriate stakeholder (such as the cleaning company) for information check or update required for the cleaner. The communication link 148 between cleaners and the consumer facing APIs is necessarily downlink only (one-way).

In preferred embodiments, the system follows a multi-tier alerting strategy where alerts sent 144 must be acknowledged in some form such as NFC card taps, app based responses, and/or others. Failure of reception of an acknowledgement about the work order can cause alerts to be sent to different stakeholders for notification of non-completion. This chain can execute until the last level of stakeholders has been exhausted whereby the system tags the work order/alert as unacknowledged or incomplete. In some implementation, the system is configured to not generate any new alerts unless a previous work order has been acknowledged. In other implementations, the system can be configured to generate new alerts and track each one for their completion.

System integrators or partners 152 are entities who implement the system for third parties. VCS provides a dashboard based login and features to allow such entities to create projects and manage the configuration of devices and alerting at various installation locations within a facility.

Users 154 represent any person or entity that utilizes VCS APIs for predictive cleaning to create their own project at any installation location. VCS provides open APIs for such users to utilize the system as a platform (Platform as a Service or PaaS). In this operation mode, appropriate dashboards and features are provided to allow easy setup of various subsystems, namely the sensor subsystem and the consumer subsystem.

An automated billing system (not shown) can be set up for all stakeholders to allow easy tracking of requests to the system, resources utilized in storage, alerts or work orders generated by the system, and/or others.

### Alert Tracking System

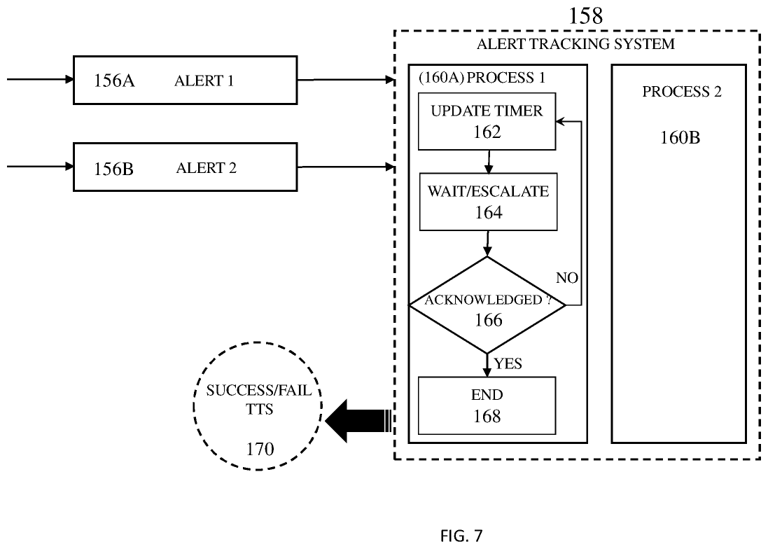

FIG. 7 depicts the alert tracking system 158 that maintains a progress of each alert generated by the analytics engine of VCS (118). For any incoming alerts such as 156A and 156B from the analytics engine, the tracking module initiates a separate process flow 160A and 160B and maintains it until a certain execution termination limit is reached. Alerts are generated by the analytics engine by means of process flows described in further points. Each alert tracking process flow starts by initiating a timer at step 162 to measure time elapsed since the alert was first received. The process then chooses to wait or escalate the alert to another level at step 164 based on certain parameters as set by the stakeholders. Levels of multi-stage alerting contains information about stakeholders to send alert to and their associated timeouts. At step 166, the process checks for the fulfilment of acknowledgement of the alert (i.e. whether a task has been completed or an issue resolved). In positive cases or absolute process timeouts, the process ends at step 168. In negative cases, the system updates the timer and the process repeats from step 162. The tracking module results in a success or failure condition indication and a time to service (TTS) values at step 170. These values are stored by the system at specific locations for use in further analytics related to calculation of reaction times of stakeholders in 144.

### Sensors

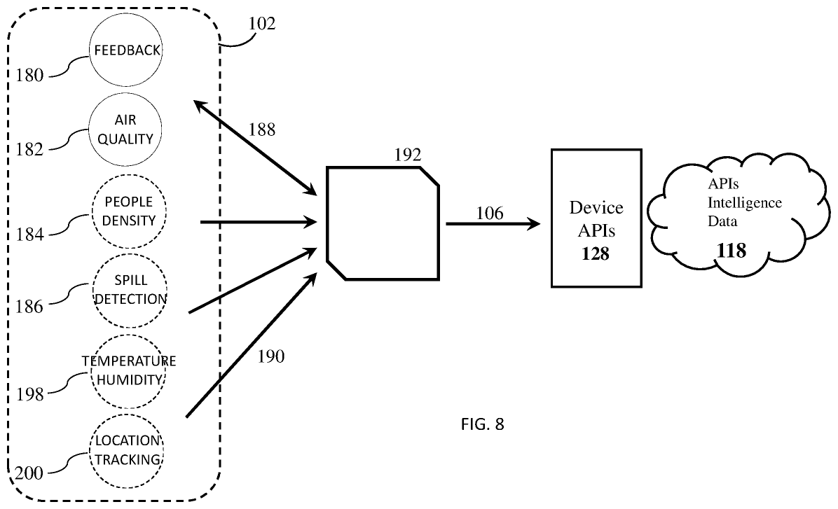

FIG. 8 depicts a system of sensors or devices (“sensors”) 102 for the virtual cleaning supervisor (VCS). The various sensors or devices can be installed in a facility to monitor its cleanliness in real-time. It is noted that camera based imaging devices and related algorithms are not preferred due to privacy policies and data protection. The sensors can be installed with fixtures for DC power supply and a provision for short-term battery based operation in case of power failures.

A user feedback module 180 can be equipped with near-field-communications (NFC) or an RFID based task logging capability. In preferred embodiments, this user feedback device is a touch screen capable of recording feedback from users about any fault in the location. Additionally, it can accept card based cleaner task logging about the status of facility location after cleaning has been performed. In some embodiments, the task logging based NFC module is separate from user feedback module. Task logging can also be performed through a mobile application indicating the time, place and/or photo of activity performed. This step serves to remove the paper based task logging systems in place or introduce a digital logging system to generate reports and track faults. In some implementations, the device can also act as a medium for business establishments to display advertisements on the screen, for example, in malls. These advertisements can be shown to users after they provide feedback. Alternatively, they can be looped until a presence is detected within few centimeters of the device. Appropriate methods are provided that allow changing of advertisement content and their presentation modes by a remote administrator. This device implements a bi-directional communication link 188 for data receipt and sending to the data analytics engine. Downlink from servers to such devices is implemented in the form of HTTP endpoints listening on some port for over-the-air (OTA) updates. The presence of this device is not necessary for the AI engine to work, though it may help in prediction accuracies and overall orchestration of the deployed system within the facility.

Indoor air quality can be a critical component for quantifying the cleanliness of any facility. Accordingly, one or more sensor or devices 182 for measuring concentrations of various indoor gases, particularly those found in indoor environments can be included. The sensors can measure approximate concentrations of various gases or an index can be calculated from these values as a measure of the air quality inside. For example, indoor environments in facilities usually report higher concentrations of odorous gases like ammonia, hydrogen sulfide, and certain other volatile organic compounds produced from sources such as aerosols, printers, paints, cleaning agents and/or others. In a preferred embodiment, the sensors operate within known error ranges and do not reflect the exact concentration values of any specific gas.

One or more air quality devices or sensors can also be important for the predictive cleaning operations by the VCS. The devices or sensors can send data to the data analytics engine at specific intervals of time (time continuous data source). In preferred implementations, the device or sensor can choose not to store and resend earlier failed messages. In other implementations, the device or sensor can sample data from the environment at a higher rate and send data only at those time durations when the change in value is consistently high. This process has two advantages. First, faulty spikes from the device or sensor can be minimized. Second, this kind of sampling and data sending algorithm allows for faster detection of any anomaly at the installation location.

In preferred embodiments, the sensors or devices implement a mechanism to detect faulty readings automatically. Probabilistic modeling of time series data being sampled for this purpose. For example, if a device or sensor is known to operate within a certain error bound for an environmental condition, a constant reading can result in higher likelihood of it being faulty. Likewise, if the device or sensor readings fluctuate abruptly for long duration of time, the chance that the device or sensor is faulty is higher. This belief can be sent by the device or sensor along with its usual data payload message and can be processed by the VCS to perform the necessary actions.

The system of sensors or devices 102 can also include a device for measuring visitor traffic or people density 184. The device can be positioned at the entrance of the installation location to detect and count the approximate number of people entering and/or leaving. This data is helpful for estimating peak usage times, when there is a greater chance of the area being dirty or requiring maintenance. This data can be utilized to allow cleaning operations to be performed strategically around such times. The device 184 can be based on passive infra-red thermopile arrays or optical based (two lasers) to estimate the direction of motion. A larger thermopile array can be used to differentiate various kinds of simultaneous enter and exit scenarios for greater accuracy. This device is an event based data source. Based on the number of visitors over time (i.e. patterns of use) the sampling rates of the other devices or sensors can be adjusted.

For facilities other than washrooms, this type of device 184 can be installed at various locations. In a hospital facility, it can be installed at lobbies and corridors to monitor people density over time. In another implementation, the sensor can be installed in areas to detect slip and fall cases and send alerts to appropriate stakeholders. Likewise, in a mall or similar facility, the sensor can be installed at strategic locations to monitor the density and schedule cleaning operations of those areas.

In some implementations, a spill/floor wetness detection module 186 can also be installed within the installation location. This module can detect water or another fluid spillage on the floor and send data to the data analytics engine. This is also an event based data source and not necessary for the functioning of VCS.

The system of sensors 102 can also include a temperature and humidity measurement sensor 198 that measures temperature and relative humidity. In one embodiment, the sensor is installed at locations such as meeting rooms in an office facility to automate air flow controls.

A location tracking system 200 can also be included to track the locations of cleaners in a task force. This data can be utilized for automatically choosing a person to contact in case of a cleaning requirement at a particular location. For example, the closest available cleaner to a site can be contacted with an SMS message. The system can be implemented utilizing Bluetooth low energy (BLE) beacons at specific locations within the facility. A coupled mobile application or tag provided to the stakeholders allows presence detection of beacons followed by location estimation by triangulation. Alternatively, the beacons are not static but are installed at fixed locations. With this arrangement, the mobile applications or tags act as beacons. Other techniques for location estimation using proprietary methods based on some electromagnetic spectrum can also be utilized.

The system can accommodate and integrate functionalities in part or completely with other devices and sensors. For example, a gas sensor, a water sensor, a motion sensor, a door sensor, a soap level sensor, a towel sensor, a light sensor, a water flow sensor, a humidity sensor, an airflow sensor and/or a chemical sensor can be included. As discussed, the sensors can monitor traffic and conditions in the area. Sensors can also monitor the use of and/or levels of consumables such as towels and soap.

The sensors and devices described above can utilize either a bidirectional 188 or uni-directional 190 communication link. All communications are facilitated by a gateway device 192 that routes traffic 106 to the data analytics engine through the device APIs 128. For WiFi based devices, this gateway can be an internet router. For other network providers such as Sigfox, LORA, nb-loT, Cellular, GSM, and/or others, this gateway can be installed by a third party to facilitate connections and network setup. In some implementations, the devices can connect to the gateway device using near filed communication protocols and devices such as Bluetooth, Bluetooth-low-energy (BLE), Zigbee, and/or other protocols relying on BLE such as IPv6 over BLE. In this case, the gateway device implements a connection to the cloud using WiFi, LAN, and/or others while maintaining a different communication protocol for the devices.

The devices necessarily run services in their firmware that allows a root remote administrator to perform firmware changes, for example, changing the WiFi SSID and password in case of WiFi connected devices and/or others. This service aims to minimize the number of physical un-mountings required to perform any firmware upgrades or changes. In preferred implementations for WiFi connected devices, this service can be available to an authenticated mobile application through BLE. For non-WiFi devices, the service can be implemented within the firmware and callable by certain APIs.

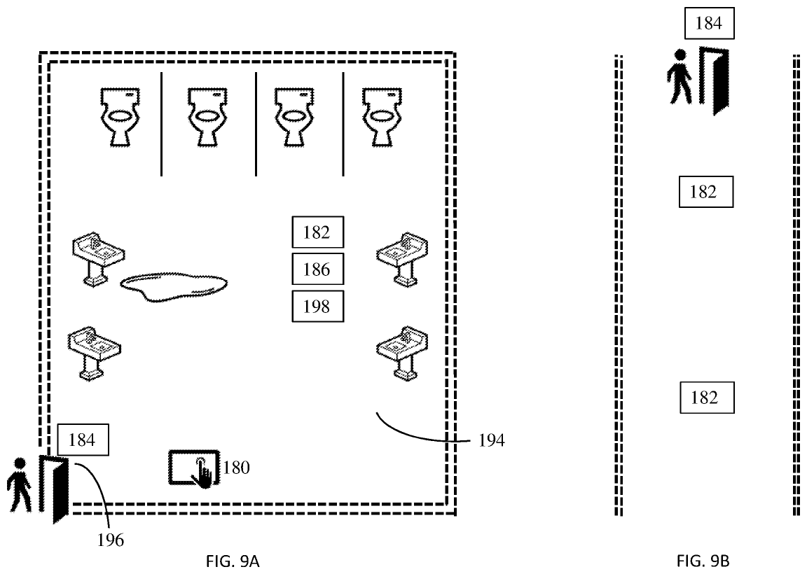

FIG. 9A depicts a washroom with sensors placed at various locations to monitor its cleanliness. A similar arrangement can be used in another closed environment such as a meeting room, cafeteria, and/or others. The entrance of the washroom is illustrated by a door 196. A people density counter 184 is installed near the entrance location to detect people entering and/or leaving.

A consumer feedback or task logging device 180 can be located near the door or exit. An air quality/gas sensor 182 can be installed near the center of the room. In a preferred embodiment, a single gas sensor module is installed per 10 ft.×10 ft. floor area at an approximate height of 10 ft.-12 ft. Multiple gas sensors can be used to cover larger areas. Spill/wetness detection modules 186 can be installed near potential sources of leakage such as wash basins, toilets, general areas and/or others. A temperature/humidity sensor is also depicted 198. If the devices are based on near field communications with a gateway (not shown), it can be installed at a location to allow the devices to reliably send data.

FIG. 9B depicts sensors in a corridor of a facility such as a mall or hospital. A people counting sensor 184 is installed in the corridor to monitor activity along with gas sensors 182.

### Process Flow

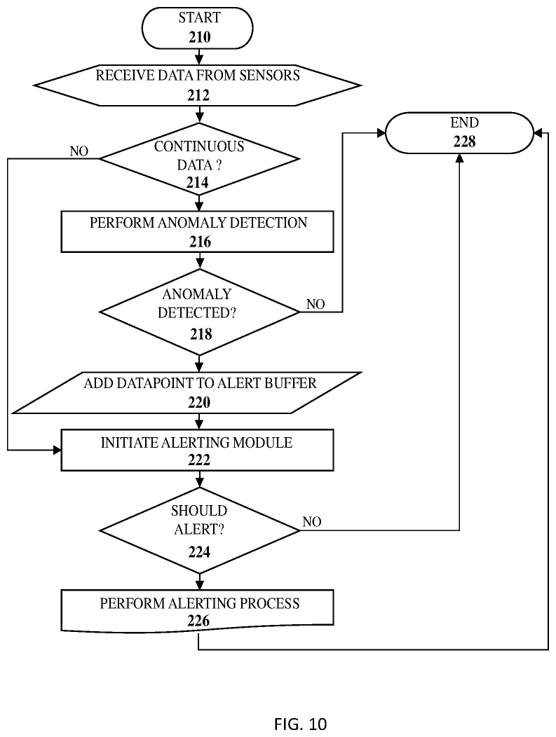

FIG. 10 is a flowchart that depicts the top-level process flow of the AI engine implemented by the VCS. Various compute modules can be executed synchronously or asynchronously. The process flow is triggered for execution by the internal APIs on reception of new data from a sensor. The internal APIs receive the respective device's unique identification string along with the data. This is utilized to query the persistent database 122 about the claims of this device, that is, which facility it belongs to and what installation location within the facility.

It is noted that each installation within a registered facility is assigned a unique identity in the database 122. The VCS collates data from multiple sensor modalities to generate predictions and analytics for every installation location within the ecosystem. The claims of a device include this information which is further passed on within the analytics module 118 as required.

The process flow can be implemented as a separate process running on the machine or as a separate thread of the main program. Implementations can vary and change according to various factors concerned with the machine running the AI engine. A maximum time out of execution may be imposed by the machine on this process flow to ensure a stable state in case of any unhandled errors leading to an indeterminate state. This flow is an important part of the VCS and has one or more termination points leading to various output decisions and information propagation concerned with the cleanliness of the particular installation within the facility.

The process is initiated at step 210 after the publish-subscribe thread of the VCS receives a trigger along-with the data from a particular sensor and its associated claims. Initiation involves spawn of a handler executor function that may itself run as a system process or thread. The VCS can run another parallel process to keep track of such ongoing processes within the system.

A typical data received at step 212 from a sensor is a serialized tensor/vector containing at least the following information: sensor's unique identity string, the sensor's data value as javascript object notation (JSON), and the installation location's unique identifier. Sensor data may also be packed according to other serialization formats such as Google's protocol buffers (protobuf), or XML. Data is deserialized and stored for further processing. For situations where payload size needs to be minimized, the sensor data may be serialized as a sequence of fixed decimal point numbers without any delimiters or keys. At this step, the process flow can also write a copy of the record to the cache memory buffer 112 described earlier. This is useful for further algorithms in the process to access historical data and perform relevant computations.

At step 216, the process performs anomaly detection to infer if the current data value is anomalous or not. The term anomaly is described as any event that deviates widely from past normal behavior of events observed during those times of days. The anomaly detection module operates only on time continuous data sources such as people usage patterns and gas sensor concentration values. The condition at step 214 checks for this continuity. If the data is not from such a sensor type, the process moves on to step 222 detailed in further sections. Several methods are implemented to extract features and perform anomaly detection on data based on a correlation measure with respect to past data. The algorithm can operate on a feature subspace obtained through time or frequency domain techniques or both. At this step, the module tries to eliminate false positives such as those generated due to cleaning activities, temporary sensor data corruption or malfunction, and/or others.

The anomaly detection module results in a binary result at step 218. If no anomaly is detected by 216 module, the process flow terminates at step 228. If an anomaly is detected by the module, it is added to an alerting buffer at step 220. This buffer maintains a sliding window of anomalies detected for any installation location within the ecosystem by any type of sensor and their time of detection.

To minimize false alerts, anomaly detection does not result in immediate alerting. Conditions are defined by module 222 further that check the collective nature of data stored in this buffer for every installation location. The nature of conditions designed in this module largely affects both the overall system's latency and accuracy in generating cleaning alerts about installation locations. While it is desired to maintain low latency in the detection of unclean installation locations within a facility, it is also desired to reduce or eliminate false cleaning alerts being sent to endpoints (cleaners). Therefore, there is an inherent compromise between the two when deciding parameters controlling module 222 of the process flow.

At step 222, data present in the alerting buffer is checked for indicating a consistent anomaly. The underlying details of this computational module have been described in further points. Module 222 sets the binary state for the decision branch at step 224. If the decision results in “no alert required,” the process flow again terminates at step 228 and the blocked alert can be added to a blocked alerts buffer. The purpose of this buffer is to send relevant alerts that were blocked currently in a future time when the alert condition results in “true” and the alert is still valid. For example, if a soap solution dispenser alert is blocked due to a task acknowledgement log reception in a short time period, this alert is placed in a buffer. At a future time, the validity of soap solution alert is re-checked with the sensor readings and the alert is sent out with another existing alert to concerned stakeholders.

If the decision at 224 evaluates to “true,” the alerting process is performed at step 226. This process deals with the task of finding appropriate endpoints to alert, message content and delivery to those endpoints. The details of this compute module are described in further points. At this step, physical cleaning or check of the concerned installation location for which the alert was raised can performed. The process then terminates at step 228.

The process flow is representative of the overall AI component of VCS. In case of node failures resulting in data loss, appropriate methods are implemented by the VCS to fetch data from the persistent database 122 and re-calculate the past beliefs to be utilized by the process flow. This failure event though rare, represents a possible downtime for the VCS and other measures might be implemented to ensure parameter consistency of the evolving model. In another alternate implementation, VCS may implement a separate process that periodically writes the parameters learned by the algorithms over time for various installation locations to persistent data storage mediums including but not limited to 122.

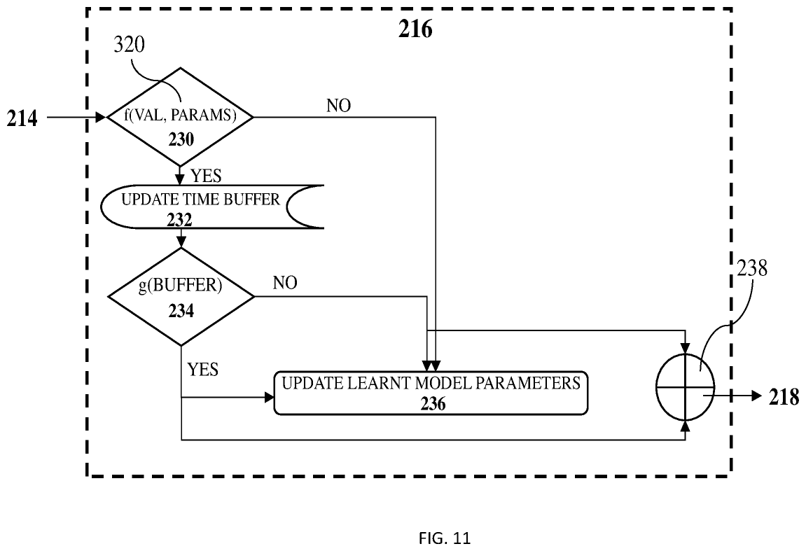

FIG. 11 depicts the anomaly detection module 216. The module's entry point is at step 214 where it checks if the data is originating from a continuous time sensor. This is because event based data, for instance, feedbacks, location data or task logs, are handled through a decision tree or “if-then-else” rules. Post initialization of module 216, the implemented AI algorithm is evaluated at step 230. Irrespective of algorithm type, it can be represented as a function f (.) that takes the current data point value as its input and maintains an estimate of certain parameters characteristic of the AI model or pattern learned. These parameters are generally represented by key PA RAMS in the figure and VAL represents the current data point. Model parameters can be quantities such as mean, variance, matrix decomposition parameters, and/or others. This function has been described in detail in further points, and for the purposes of understanding module 216, it is agreed that function f (.) results in a boolean decision of whether the input observed data point is an anomaly or not. PARAMS are calculated for each sensor data model based on past data trend across multiple time units (minutes, hours or days). The system necessarily maintains a model zoo allowing multiple models to be applied on the incoming data stream from any sensor. These machine learning model parameters may be batch updated or online updated. Batch update implies that model parameters are calculated at specific time intervals of day based on history of data. Online update implies that the model parameters are updated with each incoming data payload from the sensor.

If no anomaly is detected at step 234, the module moves to step 236 for logging parameter updates resulting from current data point in the cache 112 for the installation location. This update helps in online training of the system with data obtained from installation locations. In some implementations, a parameter p can be updated iteratively to a new value according to update rule pₜ₊₁=αpₜ+(1−α)pₜ₊₁. The parameter α∈[0, 1] denotes the momentum parameter that controls its rate of change with respect to new values observed. This parameter may have higher values for non-anomalous data points and lesser values for anomalous data points. The update rules ensure that the parameters learnt by the VCS are characteristic of the latest physical condition of any installation location. For example, installation of a new automated air freshener system will cause an increase in base level gas sensor values that, if not accounted for, can result in false positive alerts. A moving window data of past few days can be utilized to maintain parameters.

If the anomaly detection process results in a positive output at step 230, a time-based buffer 232 is updated. This buffer stores a certain number of past positive anomalies detected by 230 for every installation location. It is used to understand the frequency of anomalous data coming from a facility's installation. This buffer is also helpful in filtering out false positives that may have been generated by the AI model 320A.

At step 234, the time buffer is evaluated by a function g(.) to generate a final decision on whether an anomaly was indeed detected. Varying the length of time buffer decreases the latency at which anomalies are detected by the system while sacrificing accuracy. This also helps in filtering out short term anomalies within any installation (automatic water spill evaporation) location from long term ones (persistently bad air quality levels than those observed at earlier times in past days). In preferred implementations, the function g(.) performs cross-correlation on time values present in the buffer t with a kernel function K: O=K*t, resulting in “true” if O exceeds a predefined threshold. This function is essentially counting the number of anomalous events within a certain time window and evaluating to “true” if the number of anomalies within a time duration is large.

The results of function g(.) are used to update the AI model parameters at step 236. Further, the binary decision resulting from evaluation at steps 234 and 230 are aggregated at step 238, representing the overall binary output of the anomaly detection compute module as a result 218 described earlier.

### Alerting Module

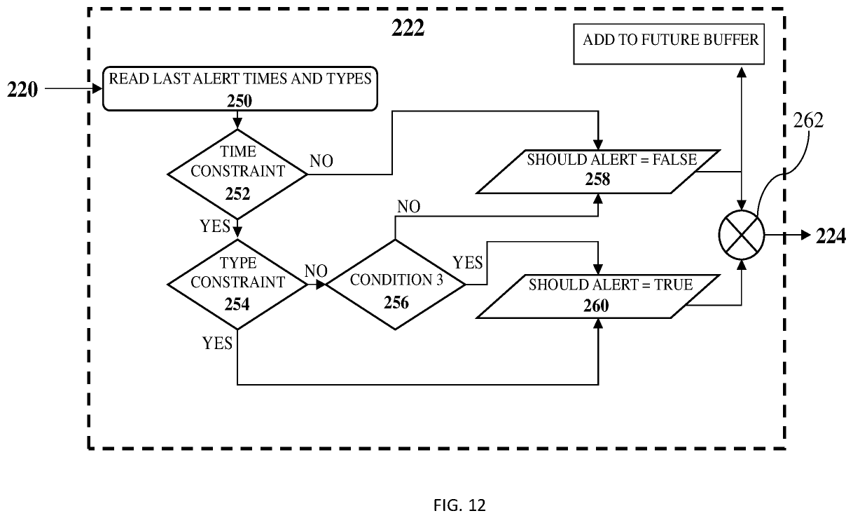

FIG. 12 depicts the alerting module 222 that evaluates whether an alert should be sent to an installation location. The module's input is the result of anomaly detection 220. At step 250, the module reads past alert times and types for the concerned installation location. These values can be stored within the program as arrays, in cache memory data structure, or as a file saved on the disk. The alerting module is based on an “if-then-else” decision process that checks for whether various conditions are fulfilled before sending an alert.

A time constraint condition is checked for compliance at step 252. This constraint is used to limit the frequency of alerts being sent out to cleaner endpoints for any installation location. If the maximum frequency of alerting for a facility is fₘₐₓ, then this condition will check for its compliance as t_{now}−tₗₐₛₜ>1/ƒₘₐₓ. In preferred implementations, the value of this threshold can be dynamically set by the VCS by considering various factors such as day of the week, time of day, and/or others. In other implementations, this value is set by either the facility manager or cleaning companies based on their mutual contract. In yet another implementation, where the system is able to provide guarantees of no errors in operation and detection, this condition can be removed thereby making a purely event based predictive cleaning model. If the result of decision step 250 evaluates to “false,” the overall output of this module is unconditionally set as “false” at step 258.

A type constraint 254 can be imposed in some embodiments. This constraint checks if the last alert of similar type was sent within a threshold time duration. For example, if an alert for bad odor in the installation location was sent earlier, the system can choose to wait for a threshold duration of time before raising an alert of the same type. This check evaluates to “true” if the last alert's type was not the same as the current one and the result of module 222 is set as “true.” If the type constraint criterion is not satisfied, that is, the current alert is generated from same sensor type as that of the last one, the process moves on to check another condition at step 256.

In another implementation, the system can keep the threshold for type constraint much lower or null. This kind of implementation is preferred in embodiments that employ the feedback and cleaner task logging device in the system. In such implementations, when an alert is raised and sent by the VCS to the concerned endpoint, the task logger changes its state to await cleaning log by a cleaner. The system can repeatedly send cleaning alerts if the state of task logger is not acknowledged by the cleaner from the previous cleaning alert. The process flow then requires the cleaners to acknowledge the receipt of alert and perform a physical check, by way of providing an NFC or RFID based card containing their unique identifiers. After a cleaning is finished and an alert is sent, the system returns to a normal state. The alerting frequency can be decreased by the system to wait for sensor readings to go back to normal.

The condition 256 can be any further constraint that the system implements that results in alerts being sent, even if the previous type condition evaluated to “false.” This condition can also be the case where a lot of user feedbacks are received in a short time interval about the re-occurrence of that alert type, thereby requiring a physical check by the cleaner (even if it was performed within a threshold time duration). As a result of this condition, the module evaluates to “true” state at 260. Step 262 is an aggregator that forwards the state of module 222 as the output to subsequent modules 224.

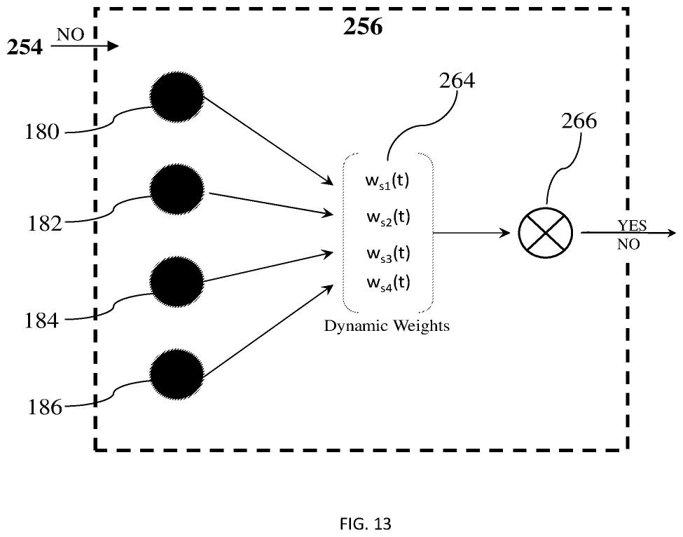

FIG. 13 depicts a detailed view of condition 256. This condition is initiated if the module 254 (alert type constraint check) evaluates to a “false” state. If the facility is not operational for 24 hours, cleaning alerts during non-office time durations can be eliminated or buffered for later delivery. Moreover, the workforce may not be present in such a facility. This is in contrast to a facility such as an airport, where the workforce is often available throughout the day and evening. This system behavior of time of day based alerting is implemented by assigning weights to the sensors installed within the facility. These normalized weights reflect the importance or contribution of that specific sensor type towards the level of urgency with which the alerts must be sent and thereby cleaning performed for that location. These dynamic weights are represented as the matrix 264. The alerting buffer 220 and anomaly detection buffer 232 can perform a weighted check on their results using 264. The result is finally passed through a function 266, for instance, logistic or sigmoid function to generate a value, whose thresholding results in a true or false as the module's output. In another example scenario, the weights of people pattern counter and the gas sensor can be increased during peak usage times of a working day. Appropriate methods can be implemented by the VCS to determine the time-based dynamic weights (represented as w(t) in the figure) assigning criteria.

### Alerting Process

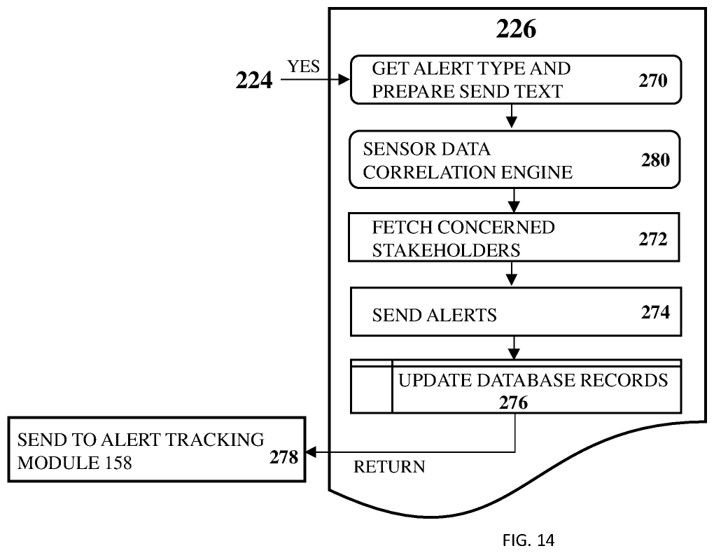

FIG. 14 depicts the steps of the alerting process 226 according to one embodiment (also referenced in FIG. 10). This process includes a step of sending alerts to cleaners if an anomaly is detected and it has been validated 224. The module can identify the type of sensor that raised the alert at step 270 and prepare the content of the message to be sent to the cleaner. At step 272, the alert is correlated against other sensors installed at the location by the correlation engine. For example, an indication of a high volume of people can implicate a poor air quality. This step allows sending more task specific alerts than general alerts about something being amiss in the specific installation location. Moreover, this can allow the attendant to carry particular equipment to deal with the alert instead of the entire array of devices. Further, the VCS can prepare simultaneous alerts to endpoints other than cleaners such as repair works and/or others if an infrastructure problem is the cause of issues being reported by sensors.

The concerned stakeholders are fetched from database 122 at step 272 and respective alert messages sent at step 274. Cleaners associated with an installation location can be assigned by cleaning companies using their dashboards. If an active mobile application installation for “VCS cleaner” is found, the delivery medium for this alert is changed from its default SMS based messaging.

Appropriate methods can be implemented by the VCS to track successful or failed deliveries through the utilized messaging mediums for sending alerts such as email, SMS, voice calls, app based notifications, and/or others. The action is retried within a certain time duration, failing which a notification is sent to the concerned stakeholders to correct the issue. Finally, the process ends at step 276 by updating the event of sending alerts in the database 122 for future access. Data recorded contains information about the type of alert sent, time of alerting, the content of the alert, and stakeholders who received this alert. This data is further utilized by the VCS during report generation for scheduled or on demand audit of activity within their respective facilities by facility managers or service quality maintenance and management by cleaning companies.

At the end of alerting process 226, the alert is passed on to the alert tracking system module 158 described in FIG. 7. Each alert independently follows its timeline leading to escalations or a resolution. In some implementations, the system can be configured to refrain from raising new alerts until a previous alert from the same installation location is resolved. In another implementation, the system sends alerts to various levels based on their independent timeouts (alerting frequency) instead of checking for the acknowledgement of a past alert.

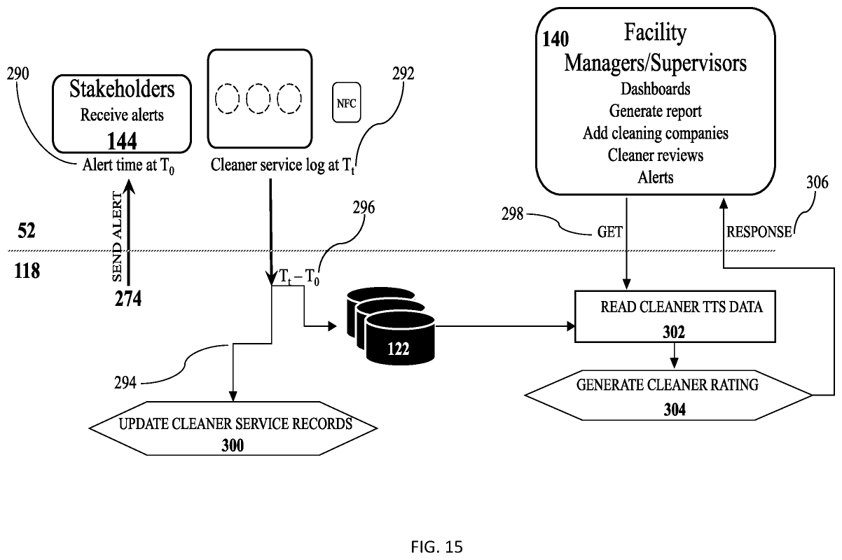

For service quality management of cleaners employed by cleaning companies, a score rating is generated by VCS based on their time-to-service (TTS) parameter calculated from the task logging module. This workflow is detailed in FIG. 15. The top components shown above the horizontal line in the figure belong to sensor subsystem 52. The cloud side algorithms and processes that reside in 118 are shown below the line. In a typical workflow, an alert is sent to a cleaner at step 274 within the process flow 226 described earlier. The time of alert sent is noted as T₀ 290. The cleaners are required to perform a physical inspection of the concerned installation location and/or any cleaning required. Following this action, they must register this task completion to the VCS by tapping their NFC/RFID enabled cards on the feedback/task logger device installed within the location. The time of this task logging or service completion acknowledgment is noted as Tₜ 292.

The task logging device sends this data back to the VCS that updates the database 122 with this TTS of Tₜ-T₀ 296 by process 300 of the internal APIs through communication link 294.

At any time, facility managers or cleaning company supervisors can request the VCS to calculate and provide cleaner task force ratings who operate within their facility through request 298 facilitated by consumer facing APIs. This request initiates the process 302 that reads TTS data about cleaners from the database. Further, cleaner ratings are generated by algorithm 304 and returned as a response to the facility manager's request at step 306. Algorithm 304 uses the TTS values of any cleaner along with other measures of cleanliness thereby noted by the sensors within the installation location that raised the alerts. A function of sorts ƒ(1/(Tₜ−T₀)) may represent the cleaner rating where higher value is better. The function ƒ(.) is chosen such that the output space of scores is bound within a desired range. An example of such a bounding function is the tanh(.) function (hyperbolic tangent). Data from modules such as the consumer feedback module are also considered and affect this cleaner rating generated.

In another embodiment, the system can activate automated and/or robotic cleaners. For example, an air-freshener can be activated based on sensor data related to air quality and/or the presence of gas. Similarly, a robotic floor cleaner or sweeper can be activated upon reaching a threshold of user traffic or upon detecting a soiled area.

### Computational Model for AI

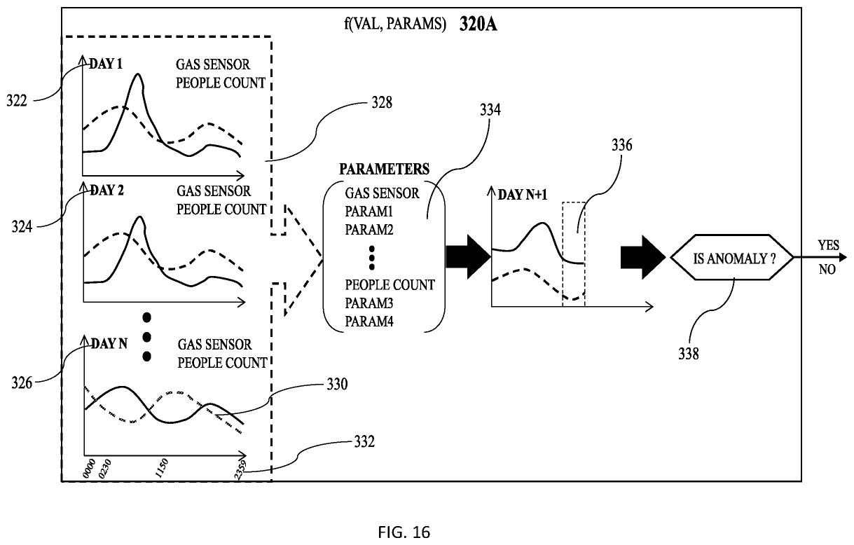

FIG. 16 depicts a computational model for AI component ƒ (VAL, PARAMS), 320A in the VCS. As described in FIG. 15, this model is evaluated at step 230 in the anomaly detection module 216 for time continuous sensor data such as air quality or people density count. The aim of this process is two-fold. It learns parameters specific to the model being used by the algorithm in an online manner (as each data point from a plurality of sensor types is received). Second, it utilizes the learnt model parameters for predicting if a data point is anomalous.

In some implementations, the system is also used as a generative model to predict future expected values of sensor data. These predicted values reflect the algorithm's belief about an installation location's usage pattern resulting from the air quality and people density count registered by respective sensors. Deviations of observed sensor values from predicted values can be used as a measure of the data point being anomalous.

In any implementation of 320A, it is desired to find a function that provides an estimate or belief of expected sensor value at any time of the 24-hour day. In preferred implementations, each day is discretized into minute interval windows for any data logging and prediction/estimation purposes. This results in exactly 1440 data points for each day of continuous time data sensor. The left dotted enclosed area in FIG. 16 depicts this setup as 328. Data from sensors is obtained and logged for various days such as 322, 324, 326, and likewise. The algorithm should learn a location's behavior based on past N days of data. Selection of N is important for the algorithm's accuracy and appropriate methods are implemented by the VCS to select a value for parameter N if different from a preset value. The value of N is chosen such that it represents an installation location's most recent state of usage patterns and air quality. This ensures that changing baseline behavior of any installation location is considered by the algorithm before predicting any anomalies. For example, installation of a new automatic air freshener system or changes in ventilation can result in a change of baseline behavior of sensor data registered during normal usages. By learning this normal base behavior for past N days and basing any algorithms on parameters learned thereby, more accurate results can be generated. Small values of N are also not desired as they cannot reflect the most accurate usage patterns. Generally, a value greater than or equal to seven days is set for parameter N, thereby covering both, weekday and weekend scenario of use cases.

In preferred embodiments, the time value is discretized at the minute interval as depicted by 332. A format of HHmm can be followed in time representation and parsing, where HH is the 24-hour format. Further, the AI algorithm can include a hash map that can convert each of the values of 332 to a continuous index from 0 to 1439 that is used for other operations as described further.

It is noted that sensor values may not be present for every minute of time. VCS therefore implements an interpolation process for generating continuous data point values as shown in 330. In preferred embodiments, spline interpolation is performed on missing data points when new data is received from a sensor. In other implementations, linear, step, polynomial, Fourier or other interpolation functions can be used.

For every data received from a sensor from an installation location, the parameters for that location 334 are updated. An example of this parameter is the mean and variance of values observed for a specific sensor around that time of the day as depicted by the dotted region 336 in continuous data plot of N+1 th day. Past data from N days for that dotted time region is queried, analyzed and parameters updated on receiving new data. The length of this time window is variable in implementations. The presence of this time window of same day maintains continuity in the estimated mean curve of sensor data trend. By comparing across multiple such past time windows, the algorithm can make a binary classification decision at step 338 indicating if the current received data point is an anomaly or not. This binary result represents the overall result of the computing module 320A that is ƒ(val, params). Various learning models including but not limited to methods such as frequency domain analysis, clustering, neural networks, regression can be utilized to learn and represent sensor value estimate for a day for 1440 time values of time. Further, absolute maximum thresholds can also be implemented by the model implying that if a sensor value is more than this threshold, it is definitely an anomaly. In another implementation, the decision of anomalous behavior may be skewed, that is, only those values that are higher than expected sensor values are considered to be anomalous and not vice versa. For example, lower than normal gas sensor values of a toxic gas such as ammonia for a given time of the day (as compared to past N days) may not be classified as being anomalous since in this case, lower values of ammonia correspond to better air quality inside a facility. However, this analogy is not valid if a comprehensive air quality index or rating is generated by the system. The historical sensor data stream spanning past few minutes or hours can also be used by the system to determine if the current data point is anomalous or not. If more than one such anomaly detection algorithms are executed in parallel, the final decision may be based on some function over the set of predictions by each of the algorithms; such as sum, average, any (OR), both (AND) and/or others.

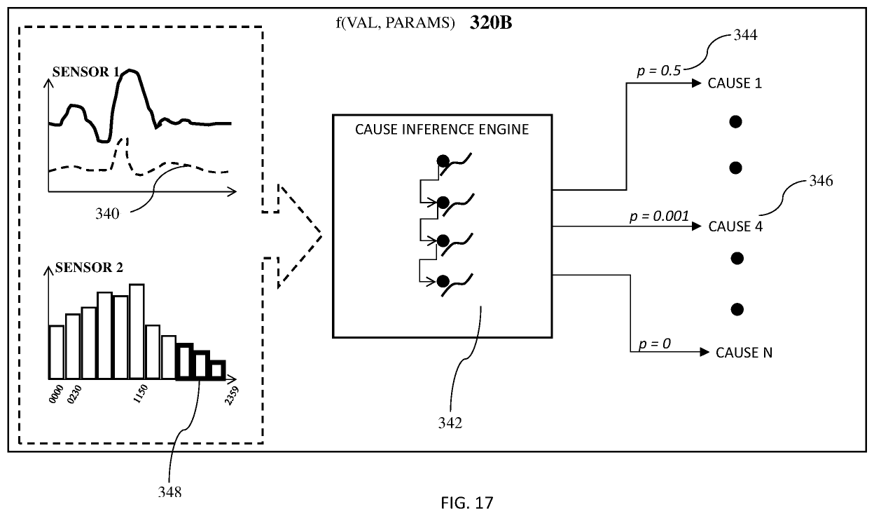

FIG. 17 depicts the cause determining generative (AI) model utilized by VCS. The aim of this model is to generate probabilistic estimates of possible causes 346 that can result in or explain the generation of a current set of sensor readings. A certain class of anomaly detection models running on sensor streams can output a goodness score as depicted by curve 340. The goodness score is indicative of the deviations of sensor reading from estimated predicted sensor readings in a defined time interval. By utilizing multiple sensor readings (340 and 348), the cause inference engine 342 learns and generates a vector describing possible causes. The system is helpful in generating a broader understanding of an installation location's cleanliness based on multiple sensor readings. The parameters of this model PARAMS can be learnt by the system over time from sensor readings or by requiring a human in the loop initially to indicate the ground truth.

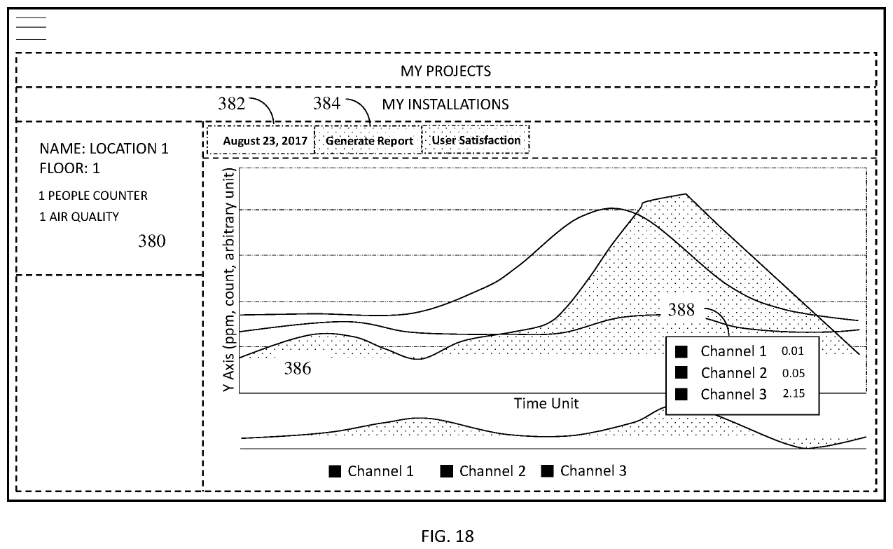

FIG. 18 is a screenshot of dashboard provided to facility managers. Various interactive components are labeled. This dashboard can be available to the stakeholders in the form of a web accessible page identified by its URL, or as an application running on their computers. In preferred implementations, the dashboards are accessible as web services. Post registration through business identity numbers and after obtaining an API access key from the service provider, the dashboard is operational to allow various functions as described in following sections. Some functions described here are indicative of a small part of the system, and additional functionalities can be added on request or removed as required. For example, some facility managers can configure a callback URL on the dashboard that allows them to receive or forward data from their installation locations in their system APIs for their processing and analysis.

The dashboard shows various installation locations of the facility as a list in its default view post login. Each facility's installed devices and other information such as its location within the facility are shown on the left pane as 380.

Function 382 allows facility managers to select a date from a dropdown for accessing data ordered by days. The data from various sensors installed is depicted as appropriate graphs (tabular, area, line, bar, annotations, and/or others) as shown by 386 and 388. A function 384 can also be provided that facilitates audit report generation for each installation location and also download data in some format such as csv, txt, and/or others. The downloaded data may contain appropriately interpolated values for sensors installed. Spline interpolated data points have been shown in this figure. Reports can be helpful to convert graphical data in tabular formats and appropriate events such as anomalous behavior, cleaner logs, alerts sent to cleaners, feedbacks from consumers using the facility and/or others summarized appropriately. Additionally, inventory management details can also be predicted and tabulated in this report. The reports can also be generated automatically at scheduled intervals by the server and delivered by appropriate mediums such as email to concerned stakeholders such as facility managers and/or cleaning companies in contract with the business establishments.

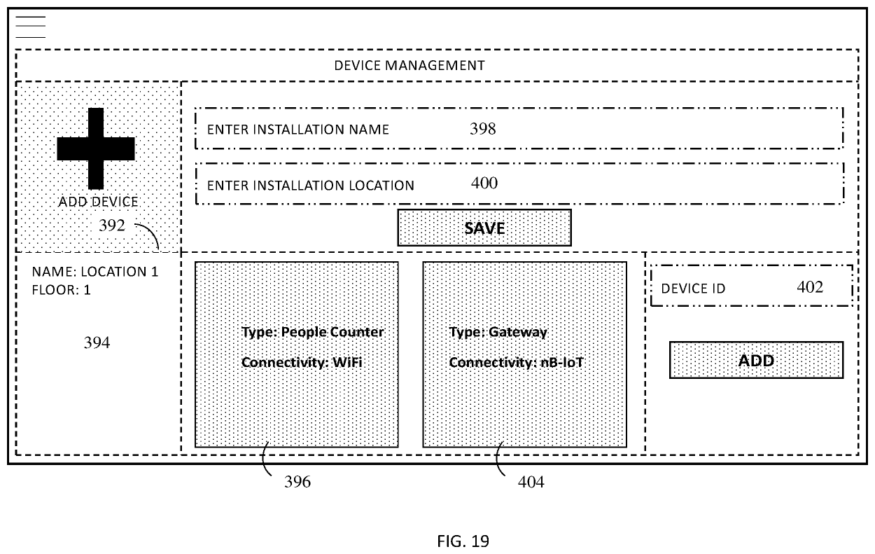

FIG. 19 depicts some functionalities of device management graphical UI for a facility manager. Facility managers can create a virtual representation of their installation locations by entering its descriptive name 398 and location 400. This information provided is crucial for facility managers to visually understand the data coming from sensor modalities installed and for the VCS to generate predictions and analytics.

Existing installation locations and attached devices are depicted in the panel below where the descriptive name 398 entered earlier are displayed as 392 and the location entered as 400 earlier, is shown as 394. Further, when a new device is purchased, installed and connected to the analytics engine 118, it can be claimed by their owners through a unique identification identity string supplied with each such device. This string is entered in input field 402, and after confirmation that it is indeed the device type with no associated users, the system associates the device's claim with the facility and indicates its installation location in this claims 396 and 404). This process is a crucial step for the VCS to be able to retrieve information about various installation locations in the system and associated devices so that data from a plurality of sensors belonging to each installation location can be collated and machine learning performed.

In preferred implementations, other web services are provided such as those for registration of a cleaner using their unique identities, registration of cleaning companies and an interface for them to search and add cleaners within their organization, service for requesting a facility manager to provide access to manage their cleaning workforce within the facility (for notification services), a dashboard for cleaners to update their personal information that is visible to cleaning companies and facility managers, and an optional mobile application for cleaners to register and receive notifications from the VCS.

### Operating Environment:

The system is typically comprised of a central server (residing on premise server or on cloud or both), that is connected by a data network to a user's computer. The central server can be comprised of one or more computers connected to one or more mass storage devices. The precise architecture of the central server does not limit the claimed invention. Further, the user's computer can be a laptop or desktop type of personal computer. It can also be a cell phone, smart phone or other handheld device, including a tablet. The precise form factor of the user's computer does not limit the claimed invention. Examples of well-known computing systems, environments, and/or configurations that may be suitable for use with the invention include, but are not limited to, personal computers, server computers, hand held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. In one embodiment, the user's computer is omitted, and instead a separate computing functionality provided that works with the central server. In this case, a user would log into the server from another computer and access the system through a user environment.

The user environment can be housed in the central server or operatively connected to it. Further, the user can receive from and transmit data to the central server by means of the Internet, whereby the user accesses an account using an Internet web-browser and browser displays an interactive web page operatively connected to the central server. The central server transmits and receives data in response to data and commands transmitted from the browser in response to the customer's actuation of the browser user interface. Some steps of the invention can be performed on the user's computer and interim results transmitted to a server. These interim results can be processed at the server and final results passed back to the user.

The methods described herein can be executed on a computer system, generally comprised of a central processing unit (CPU) that is operatively connected to a memory device, data input and output circuitry (I/O) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the I/O circuitry or the data communication circuitry. The data stored in memory can be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The I/O devices can include a display screen, loudspeakers, microphone and a movable mouse that indicate to the computer the relative location of a cursor position on the display and one or more buttons that can be actuated to indicate a command.

The computer can display on the display screen operatively connected to the I/O circuitry the appearance of a user interface. Various shapes, text and other graphical forms are displayed on the screen as a result of the computer generating data that causes the pixels comprising the display screen customer's actuation of the browser user interface. Some steps of the invention can be performed on the user's computer and interim results transmitted to a server. These interim results can be processed at the server and final results passed back to the user.

The invention can also be entirely executed on one or more servers. A server can be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server can be partitioned and accomplished on multiple servers that are operatively connected by a computer network by means of appropriate inter process communication. In addition, the access of the web services can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application. The precise architecture of the central server does not limit the claimed invention. In addition, the data network can operate with several levels, such that the user's computer is connected through a fire wall to one server, which routes communications to another server that executes the disclosed methods.

Computer program logic implementing all or part of the functionality previously described herein can be embodied in various forms, including, but in no way limited to, a source code form, a computer executable form, and various intermediate forms (e.g., forms generated by an assembler, compiler, linker, or locator.) Source code can include a series of computer program instructions implemented in any of various programming languages (e.g., an object code, an assembly language, or a high-level language such as C, C++, C #, Action Script, PHP, EcmaScript, JavaScript, JAVA, or 5 HTML) for use with various operating systems or operating environments. The source code can define and use various data structures and communication messages. The source code can be in a computer executable form (e.g., via an interpreter), or the source code can be converted (e.g., via a translator, assembler, or compiler) into a computer executable form.

The invention can be described in the general context of computer-executable instructions, such as program modules, being executed by a computer.

Generally, program modules include routines, programs, objects, components, data structures, etc., that perform particular tasks or implement particular abstract data types. The computer program and data can be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data can be fixed in any form in a signal that is transmittable to a computer using any of various communication technologies, including, but in no way limited to, analog technologies, digital technologies, optical technologies, wireless technologies, networking technologies, and internetworking technologies. The computer program and data can be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention can, if desired, be implemented in ROM (read-only memory) form. The software components can, generally, be implemented in hardware, if desired, using conventional techniques.

The invention can also be practiced in distributed computing environments where tasks are performed by remote processing devices that are linked through a communications network. In a distributed computing environment, program modules can be located in both local and remote computer storage media including memory storage devices. Practitioners of ordinary skill will recognize that the invention can be executed on one or more computer processors that are linked using a data network, including, for example, the Internet. In another embodiment, different steps of the process can be executed by one or more computers and storage devices geographically separated but connected by a data network in a manner so that they operate together to execute the process steps. In one embodiment, a user's computer can run an application that causes the user's computer to transmit a stream of one or more data packets across a data network to a second computer, referred to here as a server. The server, in turn, can be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, the relational database can be housed in one or more operatively connected servers operatively connected to computer memory, for example, disk drives. In yet another embodiment, the initialization of the relational database can be prepared on the set of servers and the interaction with the user's computer occur at a different place in the overall process.

It should be noted that the flow diagrams are used herein to demonstrate various aspects of the invention, and should not be construed to limit the invention to any particular logic flow or logic implementation. The described logic can be partitioned into different logic blocks (e.g., programs, modules, functions, or subroutines) without changing the overall results or otherwise departing from the true scope of the invention. Oftentimes, logic elements can be added, modified, omitted, performed in a different order, or implemented using different logic constructs (e.g., logic gates, looping primitives, conditional logic, and other logic constructs) without changing the overall results or otherwise departing from the true scope of the invention.

It will be appreciated that variations of the above disclosed and other features and functions, or alternatives thereof, can be combined into other systems or applications. Also, various unforeseen or unanticipated alternatives, modifications, variations or improvements therein can be subsequently made by those skilled in the art which are also intended to be encompassed by the following claims.

Although embodiments of the current disclosure have been described comprehensively, in considerable detail to cover the possible aspects, those skilled in the art would recognize that other versions of the disclosure are also possible.

1.-23. (canceled)

24. A system for predictive cleaning of a facility comprised of:
a) one or more sensors positioned in the facility for collecting sensor data on air quality, people count, dispenser fill levels, temperature, humidity and/or wetness;
b) an interface for receiving input from users and/or facility workers;
c) a database for storing sensor data and input from users and/or facility workers; and
d) an analytics engine comprising an anomaly detection module and an alerting module,
wherein the anomaly detection module detects anomalies in sensor data, wherein the anomaly detection module operates on continuous sensor data and comprises an anomaly detection buffer;
wherein the alerting module comprises an alerting buffer, wherein positive detection of an anomaly is added to the alerting buffer, wherein the anomaly detection buffer and alerting buffer performs a weighted check on their output based on dynamic weights of the one or more sensors;
wherein the analytics engine schedules cleaning and/or maintenance based on anomaly detection; and
wherein the analytics engine predicts cleaning and/or maintenance needs based on patterns of sensor data and/or input from users and/or facility workers.

25. The system of claim 24, wherein anomalies are one or more of poor air quality, a high people count, water on floors or counters and negative user comments.

26. The system of claim 24, wherein the one or more sensors have sampling rates that are adjusted based on patterns of facility use; and the one or more sensors include at least one of a gas sensor, a water sensor, a motion sensor, a door sensor, a soap level sensor, a towel sensor, a light sensor, a water flow sensor, a humidity sensor, an airflow sensor and a chemical sensor.

27. The system of claim 24, wherein an alert tracking module measures the time for a maintenance worker to respond to an anomaly.

28. The system of claim 24, wherein sensor data and input from users and/or facility workers is compiled into reports; wherein sensor data and input from users and/or facility workers from a first facility is used to estimate cleaning and maintenance schedules for a second facility.

29. The system of claim 24, including one or more digital dashboards to configure installation, review reports and adjust system settings.

30. The system of claim 24, wherein the user interface for user input and/or input from facility workers comprises a touch screen and/or an application for a smart phone.

31. The system of claim 24, wherein the analytics engine uses machine learning and/or artificial intelligence.

32. The system of claim 24, wherein the facility is a washroom, kitchen, lounge, dining area, conference center, auditorium, gym or a recreation area.

33. A computer implemented method for predictive cleaning of a facility comprised of steps of:
a) collecting continuous sensor data from sensors and/or devices;
b) collecting user input from a user interface;
c) identifying anomalies in the continuous sensor data with an anomaly detection module comprising an anomaly detection buffer, wherein positive detection of an anomaly is added to an alerting buffer in an alerting module,
wherein the anomaly detection buffer and the alerting buffer perform a weighted check on their output based on the dynamic weights of the continuous sensor data from the sensors and/or devices;
d) alerting one or more workers and/or stakeholders;
e) determining an alert time-to-completion for anomalies; and
f) predicting cleaning and/or maintenance needs based on patterns of sensor data and/or user input,
wherein user input includes information entered by washroom visitors and/or facility workers.

34. The method of claim 33, wherein the sensors and/or devices include at least one of a gas sensor, a water sensor, a motion sensor, a door sensor, a soap level sensor, a towel sensor, a light sensor, a water flow sensor, a humidity sensor, an airflow sensor and a chemical sensor.

35. The method of claim 33, wherein an algorithm is used in the step of identifying anomalies,
wherein the algorithm uses frequency domain techniques, time domain techniques or a hybrid approach,
wherein the step of identifying anomalies further comprises:
steps of detecting absolute maximum value thresholds, and
a step of learning and maintaining an estimate of trends.

36. The method of claim 33, further comprising a step of estimating cleaning efficiency based on an alert time-to-completion for anomalies; and
rating a facility based on sensor data, user input, anomalies and/or cleaning efficiency.

37. The method of claim 33, including a step of maintaining a historical record of sensor data and/or anomalies; and determining a likely cause of an anomaly based on the historical record of sensor data and/or anomalies.

38. The method of claim 33, further comprising a step of activating one or more autonomous or self-cleaning systems based on sensor data, user input and/or anomalies; and activating an air-freshener based on sensor data related to air quality and/or the presence of gas.
